(19) United States
(12) Patent Application Publication
(10) Pub. No.: US 2021/0149556 A1
(43) Pub. Date: May 20, 2021

(54) SYSTEM AND METHOD FOR GRAPHICAL MENU MANAGEMENT

(71) Applicant: DELL PRODUCTS, LP, Round Rock, TX (US)

(72) Inventors: Parminder Singh Sethi, Ludhian (IN); Madhuri Dwarakanath, Bangalore (IN); Avinash Vishwanath, Bangalore (IN)

(21) Appl. No.: 16/686,836

(22) Filed: Nov. 18, 2019

(51) Int. Cl. G06F 3/0488; G06F 16/245; G06F 3/044; G06F 3/0482

(52) U.S. Cl. CPC G06F 3/04883; G06F 3/0482; G06F 3/044; G06F 16/245

(57) ABSTRACT

Graphical menu management may be based on variable-length inputs to a touch sensitive display. An information handling system displays a graphical user interface presenting a listing of messages, channels, or other content. When a user makes a gestural input to the touch sensitive display, the information handling system determines a relative length of the input. The information handling system generates a menu of options based on the relative length of the input.

### FIELD OF THE DISCLOSURE

This disclosure generally relates to information handling systems, and more particularly relates to touch and swipe menu management on touch sensitive displays.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

Graphical menu management may be based on variable-length inputs to a touch sensitive display. An information handling system displays a graphical user interface presenting a listing of messages, channels, or other content. When a user makes a gestural input to the touch sensitive display, the information handling system determines a relative length of the input. The information handling system generates a menu of options based on the relative length of the input.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a generalized information handling system;

FIGS. 2-3 illustrate graphical menu configuration, according to exemplary embodiments;

FIGS. 4-5 illustrate menu management, according to exemplary embodiments;

FIGS. 6-10 illustrate characteristics of graphical swiping motions, according to exemplary embodiments;

FIG. 11 illustrates a database of menus, according to exemplary embodiments;

FIG. 12 illustrates configurable sizing parameters, according to exemplary embodiments;

FIGS. 13A-13B illustrate a menu of options, according to exemplary embodiments; and

FIG. 14 is a flowchart illustrating a method or algorithm for graphical menu configuration, according to exemplary embodiments.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings.

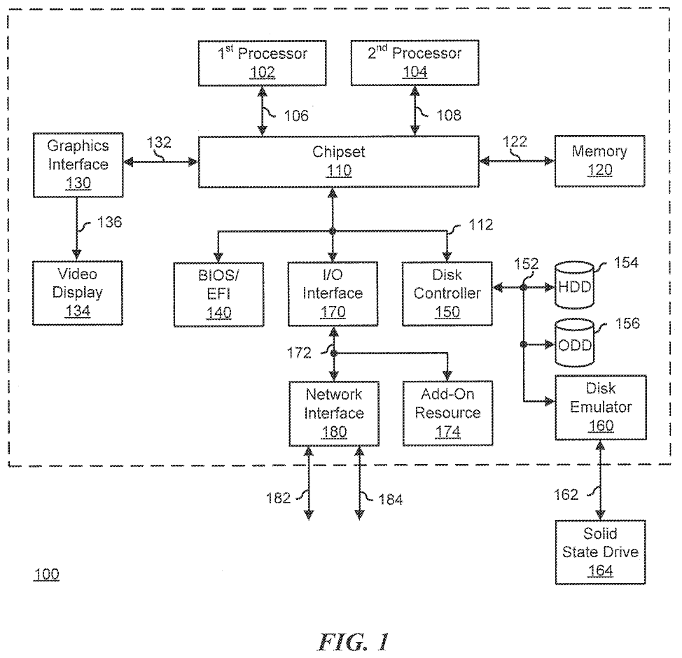

FIG. 1 illustrates an embodiment of an information handling system 100 including processors 102 and 104, chipset 110, memory 120, graphics adapter 130 connected to video display 134, non-volatile RAM (NV-RAM) 140 that includes a basic input and output system/extensible firmware interface (BIOS/EFI) module 142, disk controller 150, hard disk drive (HDD) 154, optical disk drive (ODD) 156, disk emulator 160 connected to solid state drive (SSD) 164, an input/output (I/O) interface 170 connected to an add-on resource 174, a trusted platform module (TPM) 176, a network interface device 180, and a baseboard management controller (BMC) 190. Processor 102 is connected to chipset 110 via processor interface 106, and processor 104 is connected to chipset 110 via processor interface 108.

Chipset 110 represents an integrated circuit or group of integrated circuits that manages data flow between processors 102 and 104 and the other elements of information handling system 100. In a particular embodiment, chipset 110 represents a pair of integrated circuits, such as a north bridge component and a south bridge component. In another embodiment, some or all of the functions and features of chipset 110 are integrated with one or more of processors 102 and 104. Memory 120 is connected to chipset 110 via a memory interface 122. An example of memory interface 122 includes a Double Data Rate (DDR) memory channel, and memory 120 represents one or more DDR Dual In-Line Memory Modules (DIMMs). In a particular embodiment, memory interface 122 represents two or more DDR channels. In another embodiment, one or more of processors 102 and 104 include memory interface 122 that provides a dedicated memory for the processors. A DDR channel and the connected DDR DIMMs can be in accordance with a particular DDR standard, such as a DDR3 standard, a DDR4 standard, a DDR5 standard, or the like. Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like.

Graphics adapter 130 is connected to chipset 110 via a graphics interface 132, and provides a video display output 136 to a video display 134. An example of a graphics interface 132 includes a peripheral component interconnect-express interface (PCIe) and graphics adapter 130 can include a four lane (×4) PCIe adapter, an eight lane (×8) PCIe adapter, a 16-lane (×16) PCIe adapter, or another configuration, as needed or desired. In a particular embodiment, graphics adapter 130 is provided on a system printed circuit board (PCB). Video display output 136 can include a digital video interface (DVI), a high definition multimedia interface (HDMI), DisplayPort interface, or the like. Video display 134 can include a monitor, a smart television, an embedded display such as a laptop computer display, or the like.

NV-RAM 140, disk controller 150, and I/O interface 170 are connected to chipset 110 via I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller 150 to HDD 154, to ODD 156, and to disk emulator 160. Disk interface 152 may include an integrated drive electronics (IDE) interface, an advanced technology attachment (ATA) such as a parallel ATA (PATA) interface or a serial ATA (SATA) interface, a SCSI interface, a USB interface, a proprietary interface, or a combination thereof. Disk emulator 160 permits a solid-state drive (SSD) 164 to be connected to information handling system 100 via an external interface 162. An example of external interface 162 includes a USB interface, an IEEE 1394 (Firewire) interface, a proprietary interface, or a combination thereof. Alternatively, SSD 164 can be disposed within information handling system 100.

I/O interface 170 includes a peripheral interface 172 that connects I/O interface 170 to add-on resource 174, to TPM 176, and to network interface device 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a sound card, data storage system, an additional graphics interface, another add-on resource, or a combination thereof. Add-on resource 174 can be on a main circuit board, a separate circuit board or an add-in card disposed within information handling system 100, a device that is external to the information handling system, or a combination thereof.

Network interface device 180 represents a network communication device disposed within information handling system 100, on a main circuit board of the information handling system, integrated onto another element such as chipset 110, in another suitable location, or a combination thereof. Network interface device 180 includes a network channel 182 that provides an interface to devices that are external to information handling system 100. In a particular embodiment, network channel 182 is of a different type than peripheral channel 172 and network interface device 180 translates information from a format suitable to the peripheral channel to a format suitable to external devices. In a particular embodiment, network interface device 180 includes a host bus adapter (HBA), a host channel adapter, a network interface card (NIC), or other hardware circuit that can connect the information handling system to a network. An example of network channel 182 includes an InfiniBand channel, a fiber channel, a gigabit Ethernet channel, a proprietary channel architecture, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processors 102 and 104, which provides various management functions for information handling system 100. In an embodiment, BMC 190 may be responsible for granting access to a remote management system that may establish control of the elements to implement power management, cooling management, storage management, and the like. The BMC 190 may also grant access to an external device. In this case, the BMC may include transceiver circuitry to establish wireless communications with the external device such as a mobile device. The transceiver circuitry may operate on a Wi-Fi channel, a near-field communication (NFC) channel, a Bluetooth or Bluetooth-Low-Energy (BLE) channel, a cellular based interface such as a global system for mobile (GSM) interface, a code-division multiple access (CDMA) interface, a universal mobile telecommunications system (UMTS) interface, a long-term evolution (LTE) interface, another cellular based interface, or a combination thereof. A mobile device may include Ultrabook, a tablet computer, a netbook, a notebook computer, a laptop computer, mobile telephone, a cellular telephone, a smartphone, a personal digital assistant, a multimedia playback device, a digital music player, a digital video player, a navigational device, a digital camera, and the like.

The term BMC may be used in the context of server systems, while in a consumer-level device a BMC may be referred to as an embedded controller (EC). A BMC included at a data storage system can be referred to as a storage enclosure processor. A BMC included at a chassis of a blade server can be referred to as a chassis management controller, and embedded controllers included at the blades of the blade server can be referred to as blade management controllers. Out-of-band communication interfaces between BMC and elements of the information handling system may be provided by management interface 192 that may include an inter-integrated circuit (I2C) bus, a system management bus (SMBUS), a power management bus (PMBUS), a low pin count (LPC) interface, a serial bus such as a universal serial bus (USB) or a serial peripheral interface (SPI), a network interface such as an Ethernet interface, a high-speed serial data link such as PCIe interface, a network controller-sideband interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

In an embodiment, the BMC 190 implements an integrated remote access controller (iDRAC) that operates to monitor and maintain system firmware, such as code stored in BIOS/EFI module 142, option ROMs for graphics interface 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as Web Services Management (WS-MAN) interface, a Management Component Transport Protocol (MCTP) or, Redfish interface), various vendor defined interfaces (such as Dell EMC Remote Access Controller Administrator (RACADM) utility, Dell EMC Open Manage Server Administrator (OMSS) utility, Dell EMC Open Manage Storage Services (OMSS) utility, Dell EMC Open Manage Deployment Toolkit (DTK) suite), representational state transfer (REST) web API, a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100, or is integrated into another element of the information handling system such as chipset 110, or another suitable element, as needed or desired. As such, BMC 190 can be part of an integrated circuit or a chip set within information handling system 100. BMC 190 may operate on a separate power plane from other resources in information handling system 100. Thus BMC 190 can communicate with the remote management system via network interface 194 or the BMC can communicate with the external mobile device using its own transceiver circuitry while the resources or elements of information handling system 100 are powered off or at least in low power mode. Here, information can be sent from the remote management system or external mobile device to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

In a typical usage case, information handling system 100 represents an enterprise class processing system, such as may be found in a datacenter or other compute-intense processing environment. Here, there may be hundreds or thousands of other enterprise class processing systems in the datacenter. In such an environment, the information handling system may represent one of a wide variety of different types of equipment that perform the main processing tasks of the datacenter, such as modular blade servers, switching and routing equipment (network routers, top-of-rack switches, and the like), data storage equipment (storage servers, network attached storage, storage area networks, and the like), or other computing equipment that the datacenter uses to perform the processing tasks.

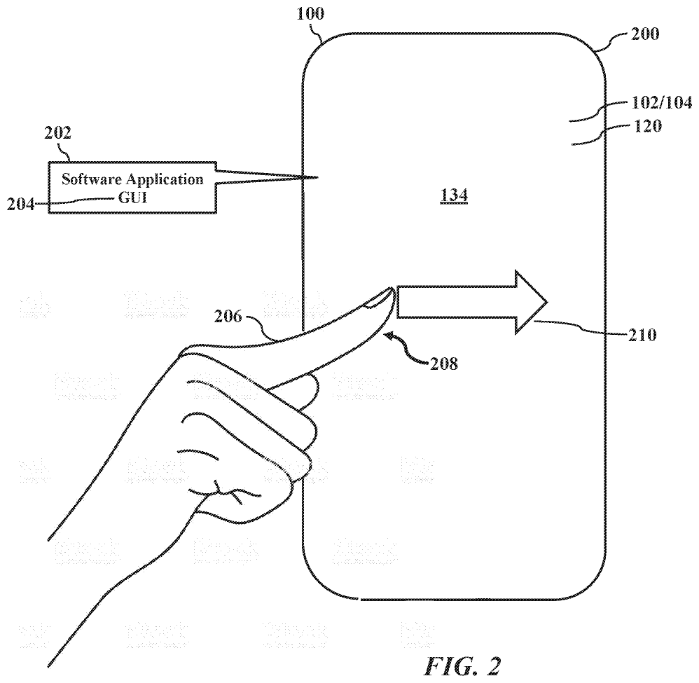

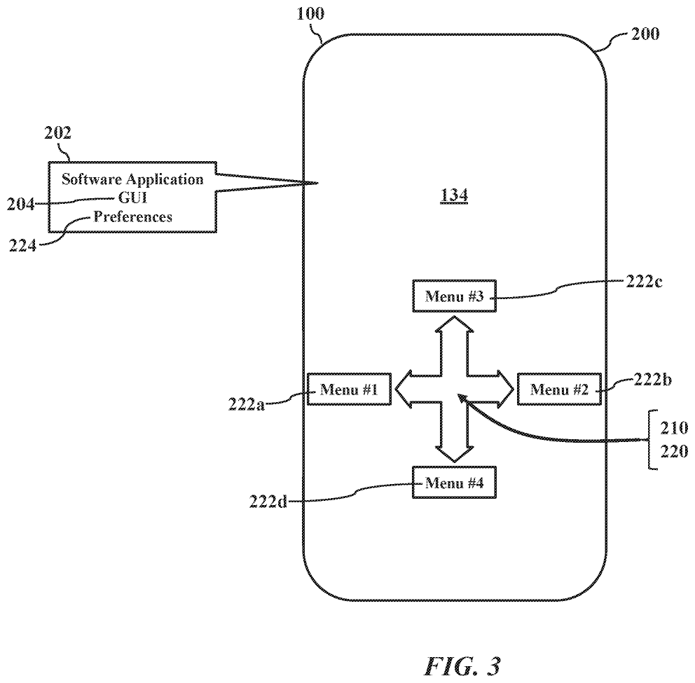

FIGS. 2-3 illustrate graphical menu configuration, according to exemplary embodiments. An information handling system such as a mobile cellular smartphone 200 includes the processor(s) 102/104 that execute a software application 202 stored in the memory device 120. When the software application 202 is executed, the software application 202 may instruct or cause the smartphone 200 to generate and display a graphical user interface (GUI) 204 on the video display 134. While the video display 134 may have any design and any construction, one common embodiment has a capacitive, touch sensitive display device. When a user's finger 206 touches the video device 134, a grid of capacitive elements (not shown for simplicity) capacitively senses the touch 208 and generates electrical output signals. Because the capacitive elements are arranged in the grid, the electrical output signals may be used to identify or infer a grid or capacitive location at which the user touched the video device 134. The smartphone 200 and the software application 202 cooperate to execute a corresponding input, selection, and/or command that is associated with the electrical output signals and/or location. The touch 208 may even be accompanied by a gesture (such as a directional swiping motion 210) that is interpreted as a corresponding action, option menu, or other function.

FIG. 3 illustrates directional configuration. When the user touches the video display 134 and enters/makes the swiping motion 210, different directions 220 of the swiping motion 210 may be defined or associated with different graphical menus 222 of options. For example, a left-to-right swipe motion 210 causes the smartphone 200 to display a first menu 222a of options. However, if the user touches and swipes in an opposite direction (such as a right-to-left swiping motion 210), the smartphone 200 and/or the software application 202 may be configured to display a second menu 222b of options. Furthermore, if the user touches and swipes in an upward direction, the smartphone 200 and/or the software application 202 may be configured to display a third menu 222c of options. A touch and downward swipe motion 210 or swiping motion 210d may be interpreted to display a fourth menu 222b of options. There may be configurations for even more directions 220 (such as diagonal swiping motions 210) and their additional, corresponding menus 222 of options. The different directions 220 and their corresponding menus 222 of options may be preconfigured by the smartphone 200 and/or by the software application 202. The user, additionally or alternatively, may select or configure preferences 224 (such as via a system or software Settings icon) that define or elect the different directions 220 and their corresponding menus 222 of options. The user's preferences 224, for example, may be established such that only certain swiping motions 210 are interpreted, while other swiping motions 210 (in different directions) may be ignored. As a simple example, the left-to-right swiping motion 210 generates/displays the first menu 222a of options. The other swiping motions 210 in different directions may be ignored and no menus are presented.

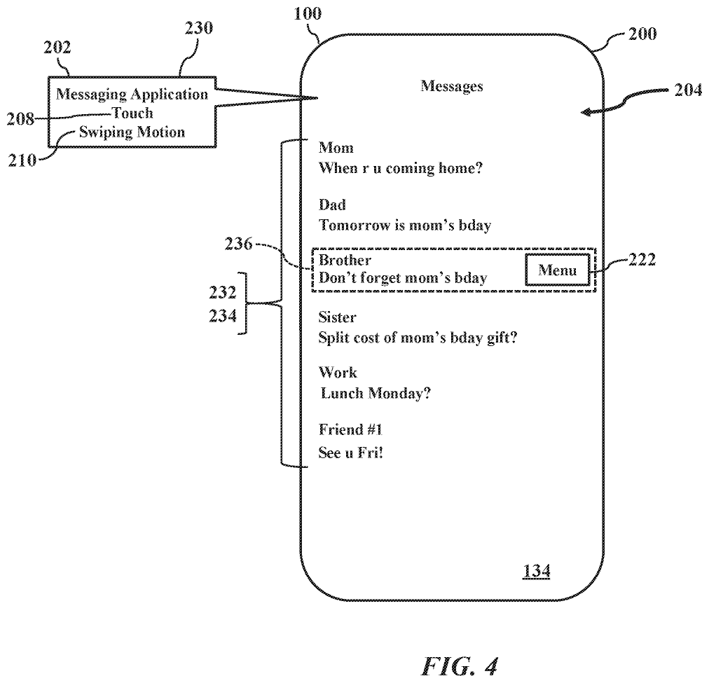

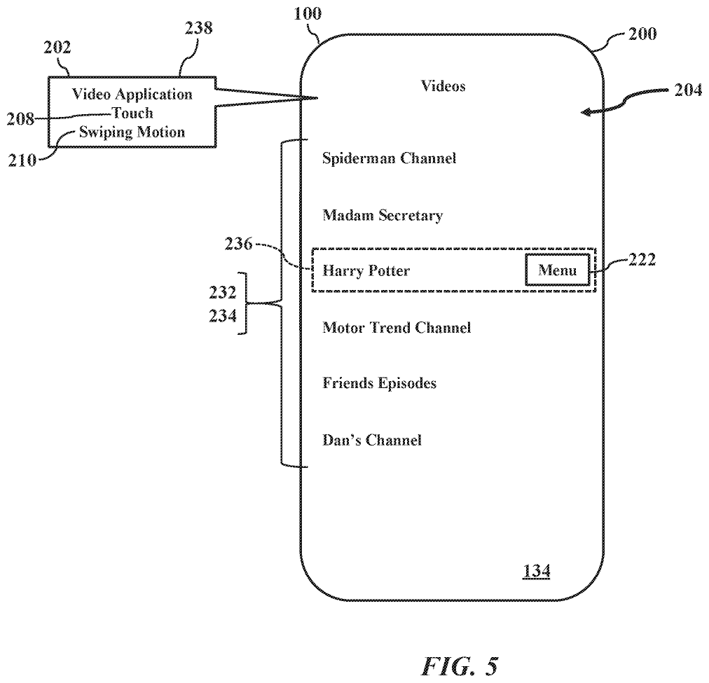

FIGS. 4-5 illustrate menu management, according to exemplary embodiments. When the information handling system 100 (illustrated as the smartphone 200) senses or detects the user's touch 208 and swiping motion 210, the smartphone 200 and/or the software application 202 generates and displays the corresponding menu 222 of options. For simplicity, suppose that software application 202 is a messaging application 230 that causes the smartphone 200 to send, to receive, and to log any electronic messages 232 (such as cellular SMS, instant messages, WI-FI® text messages, electronic mail messages). The messaging application 230 also causes the smartphone 200 to generate the graphical user interface 204 displaying a listing 234 of content. Here the listing 234 of content lists or presents the electronic messages 232 that have been sent and received. When the user touches an entry 236 in the listing 234 and swipes, the video display 134 senses or detects both the user's touch 208 and the contiguous swiping motion 210. The video display 134, the smartphone 200, and/or the software application 202 then cooperate to interpret the corresponding capacitive signals and to display the corresponding menu 222 of options.

FIG. 5 also illustrates menu management. Here the software application 202 is a video application 238 that causes the smartphone 200 to request and to receive digital videos (such as streaming programs/movies, YOUTUBE® and other video channels, and gaming applications). The video application 238 causes the smartphone 200 to generate the graphical user interface 204 displaying the listing 234 of content, with each entry 26 corresponding to a different video offering. When the user touches any entry 236 and swipes, the video display 134 senses or detects both the user's touch 208 and the contiguous swiping motion 210. The video display 134, the smartphone 200, and/or the software application 202 then cooperate to interpret the corresponding capacitive signals and to display the corresponding menu 222 of options.

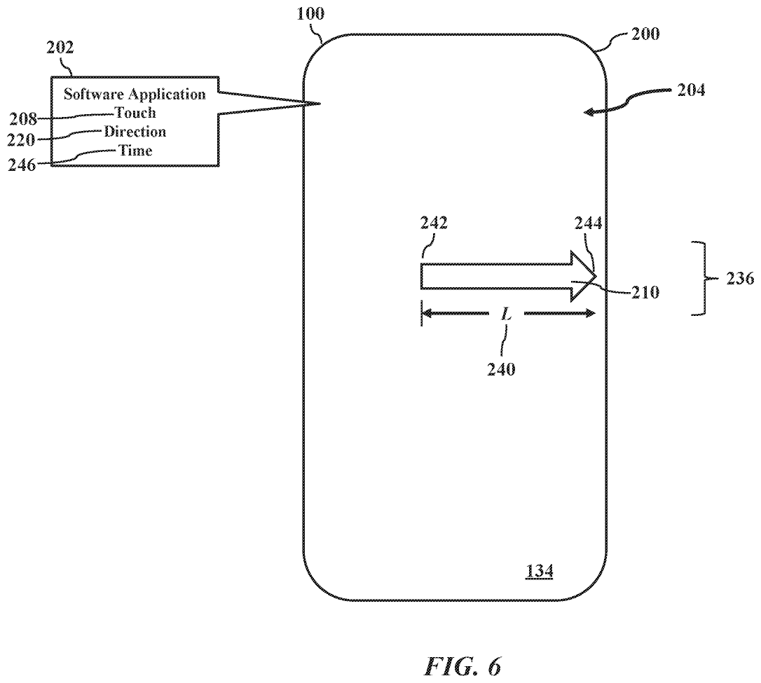

FIGS. 6-10 illustrate characteristics of the swiping motion 210, according to exemplary embodiments. The characteristics, parameters, or features associated with the user's swiping motion 210 may determine the corresponding option in the menu 222 of options. As an example, FIG. 6 illustrates the user's swiping motion 210 described or defined as a distance or length L (illustrated as reference numeral 240). When the user makes her initial touch input 208, the video display 134, the smartphone 200, and/or the software application 202 cooperate to mark or interpret the engagement with an initial location/coordinates 242. As the user then makes her contiguous, continuous swiping motion 210 (without lifting her finger), the video display 134, the smartphone 200, and/or the software application 202 cooperate to mark, trace, and/or interpret the corresponding time-based location/coordinates. When the user lifts her finger, the video display 134, the smartphone 200, and/or the software application 202 cooperate to mark or interpret the disengagement with a final location/coordinates 244. Exemplary embodiments may thus trace and/or time the swiping motion 210 from the initial location 242 to the final location 244 to determine the direction 220, the length 240, and a time 246 associated with the swiping motion 210.

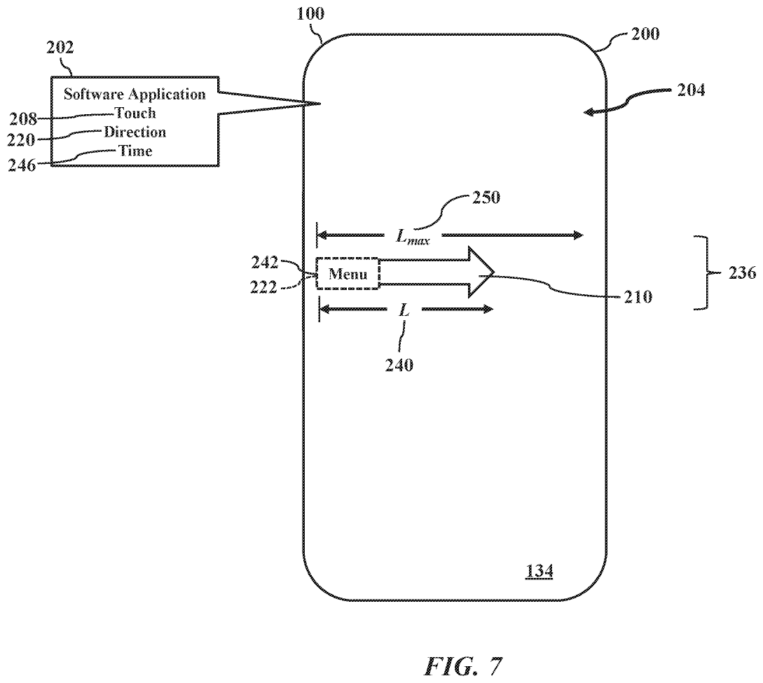

FIG. 7 illustrates determinations of the menu 222 of options, according to exemplary embodiments. Once the direction 220, the length 240, and/or the time 246 associated with the swiping motion 210 is determined, those characteristics may determine the menu 222 of options that is displayed to the user of the smartphone 200. Suppose, for example, that the user's swiping motion 210 has a maximum possible or permissible length Lₘₐₓ (illustrated as reference numeral 250). That is, the smartphone 200 and/or the software application 202 may be configured to interpret no swiping motions 210 that exceed the length Lₘₐₓ. While the length Lₘₐₓ may be set by the user, by the manufacturer of the smartphone 200, and/or by the software application 230, the length Lₘₐₓ may be defined or limited by display screen size, window sizing, text field sizing, font size, and/or other physical or visual dimensions. The corresponding menu 222 of options may then be displayed. While the smartphone 200 may display the menu 222 of options at any pixel location on the video display 134, FIG. 7 illustrates an origin location. That is, the menu 222 of options may be oriented proximate to the engagement with at the initial location/coordinates 242 (e.g., leading edge) of the user's swiping motion 210. The displayed location of the menu 222 of options, however, may be configurable by the manufacturer or by the user (such as a trailing edge of the user's swiping motion 210).

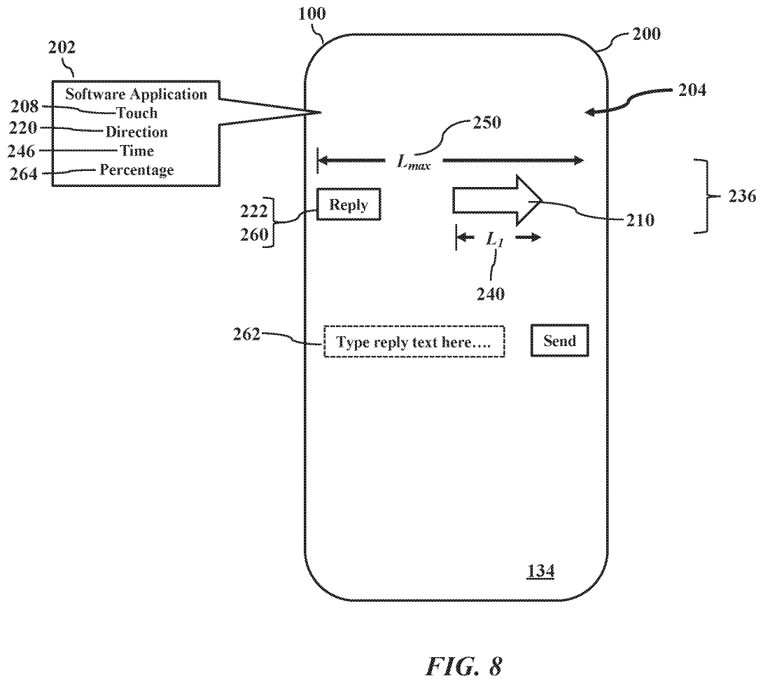

FIG. 8 illustrates a “Reply” option 260. Whatever the actual value of the length Lₘₐₓ (illustrated as reference numeral 250), the comparative actual length L (illustrated as reference numeral 240) of the swiping motion 210 may determine the menu 222 of options that is displayed. FIG. 8, for example, illustrates a short swiping motion 210 of length L₁ (illustrated as reference numeral 262) that corresponds to the “Reply” option 260 in the menu 222 of options. In other words, when the user swipes approximately the short length L₁, the “Reply” option 260 is displayed. The user may thus swipe the short length L₁, lift her finger/thumb, and touch the corresponding “Reply” icon or option 260. The video display 134, the smartphone 200, and/or the software application 202 cooperate to display a text field 262 that allows the user to type/enter her reply text and send, which the reader understands and need not be explained.

Comparisons may be made. When the user inputs the short swiping motion 210, exemplary embodiments determine the direction 220, the length 240, and the time 246 associated with the user's short swiping motion 210. The smartphone 200 and the software application 202 cooperate to compare the length 240 of the short swiping motion 210 to the maximum length Lₘₐₓ (illustrated as reference numeral 250). The smartphone 200 and/or the software application 202, for example, may determine a percentage 264 or other threshold of the actual length L of the swiping motion 210 to the maximum length Lₘₐₓ according to the ratio L/Lₘₐₓ×100=percentage. Once the actual length L of the swiping motion 210 is max calculated, its comparison to the maximum length Lₘₐₓ may cause the smartphone to display the “Reply” option 260.

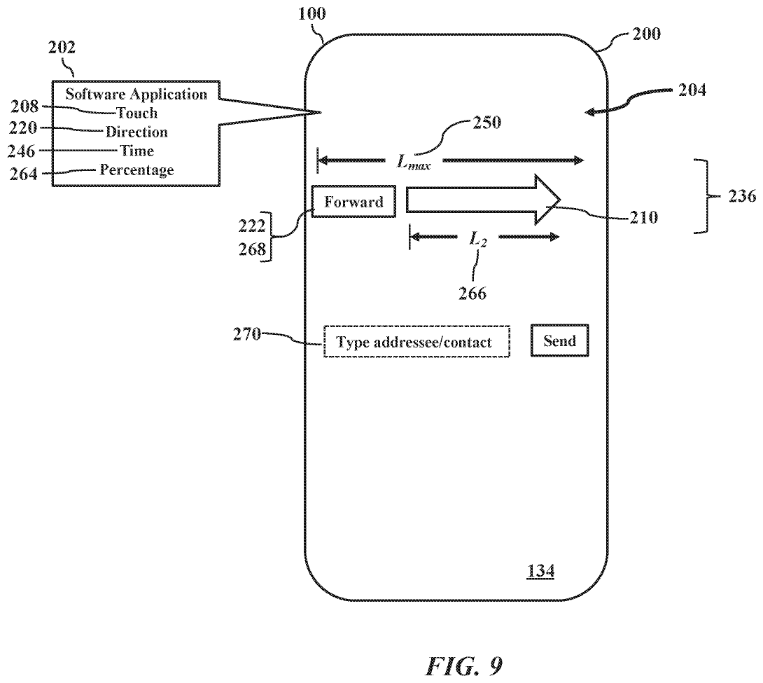

FIG. 9 illustrates forwarding of the entry 236. Suppose the user touches and makes a medium or intermediate swiping motion 210 of length L₂ (illustrated as reference numeral 266). The swiping motion 210 of length L₂ causes the smartphone 200 to display a corresponding “Forward” option 268 in the menu 222 of options. The user touches the “Forward” icon or option 268 and the smartphone displays an address field 270 for entering a forwarding address/contact/recipient, which the reader understands and need not be explained. When the user inputs the swiping motion 210 of length L₂, exemplary embodiments determine the direction 220, the length 240, and the time 246 associated with the user's medium or intermediate swiping motion 210. The smartphone 200 and the software application 202 cooperate to compare the length 266 of the swiping motion 210 to the maximum length Lₘₐₓ. The smartphone 200 and/or the software application 202, for example, may determine the threshold or percentage 264 of the actual length L₂ of the swiping motion 210 to the maximum length Lₘₐₓ.

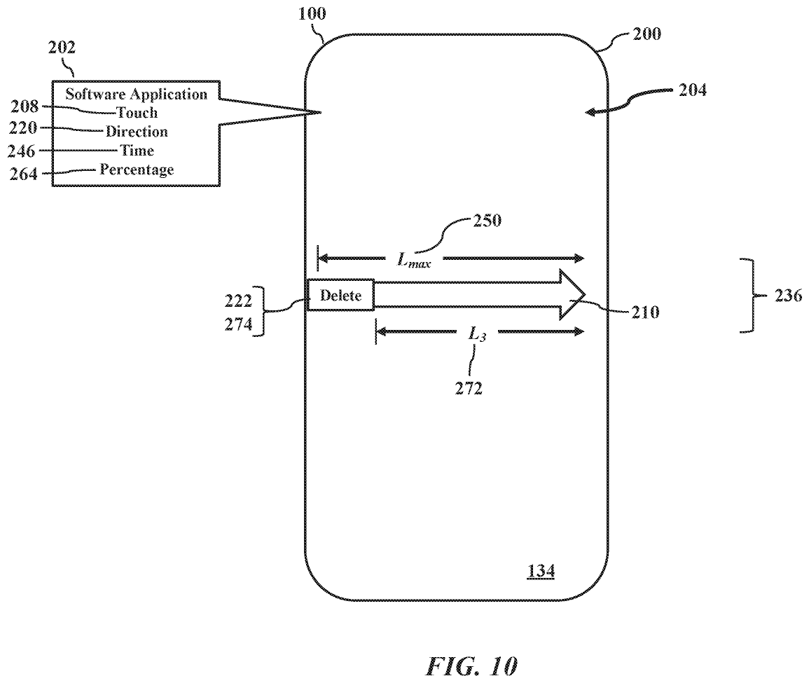

FIG. 10 illustrates deleting of the entry 236. Suppose the user touches and makes a longer swiping motion 210 of length L₃ (illustrated as reference numeral 272). Here the length L₃ corresponds to a “Delete” option 274 in the menu 222 of options. The user touches the “Delete” icon or option 274 and the smartphone deletes the corresponding entry 236, which the reader understands and need not be explained. Although not shown, the user may be prompted to confirm deletion of the entry 236, as a precaution. When the user inputs the swiping motion 210 of length L₃, exemplary embodiments determine the direction 220, the length 240, and the time 246 associated with the user's long swiping motion 210. The smartphone 200 and the software application 202 cooperate to compare the length 240 of the swiping motion 210 to the maximum length Lₘₐₓ. The smartphone 200 and/or the software application 202, for example, may determine the threshold or percentage 264 of the actual length L of the swiping motion 210 to the maximum length Lₘₐₓ.

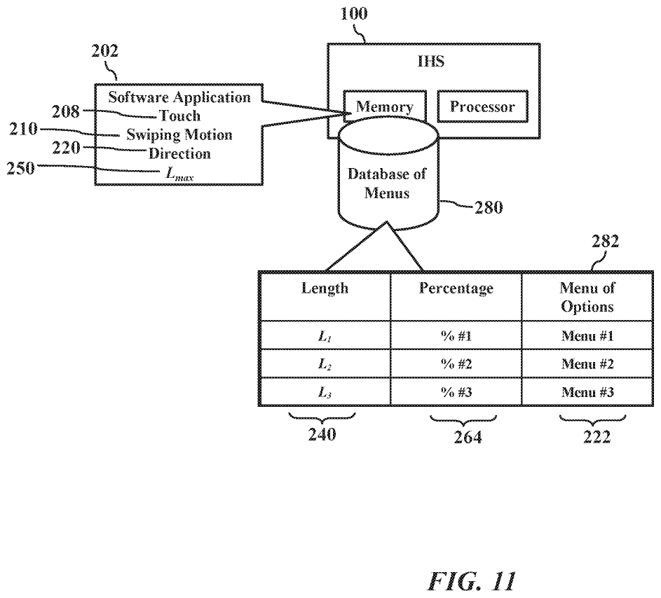

FIG. 11 illustrates a database 280 of menus, according to exemplary embodiments. When the user inputs her initial touch 208 and the contiguous swiping motion 210 to disengagement, exemplary embodiments determine the direction 220 and the length 240 (as explained above). The information handling system 100 and/or the software application 202 may then consult or query the electronic database 280 to determine the corresponding menu 222 of options. The electronic database 280 is illustrated as being locally stored and maintained by the information handling system 100, but any of the database entries may be stored at any remote, accessible location via a communication network. The electronic database 124 relates, maps, or associates different values of the length 240 and/or the percentage 264 to their corresponding menu 222 of options. While the electronic database 280 may have any logical and physical structure, a relational structure is thought perhaps easiest to understand. FIG. 11 thus illustrates the electronic database 280 as a table 282 that relates, maps, or associates each length 240 and/or each percentage 264 to its corresponding menu 222 of options. So, once the length 240 and/or the percentage 264 associated with the user's swiping motion 210 is determined, exemplary embodiments may query the electronic database 280 to identify its corresponding menu 222 of options. While FIG. 11 only illustrates a simple example of a few entries, in practice the electronic database 280 may have many entries that detail a rich depository of different swiping motions 210 and their corresponding menu 222 of options, commands, and/or selections.

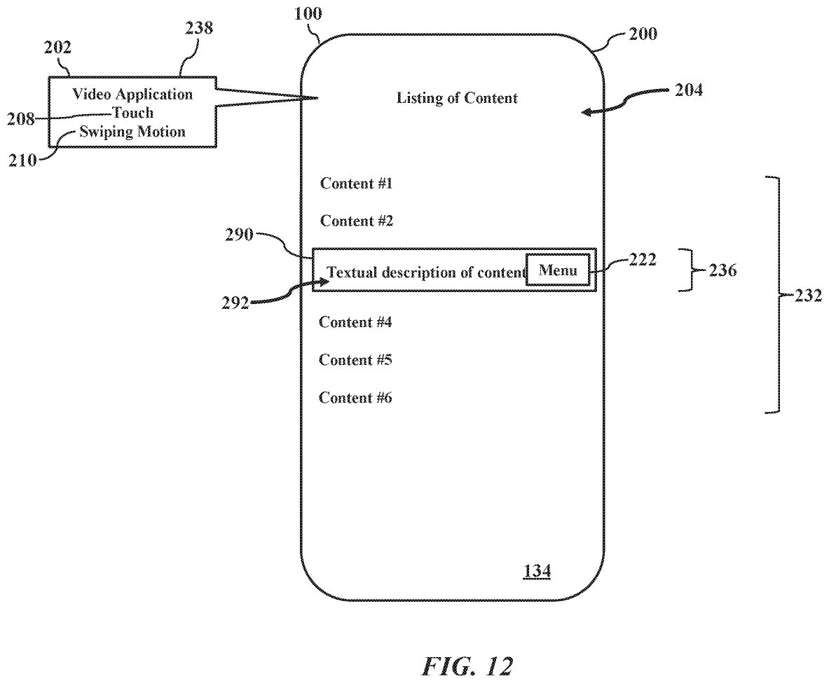

FIG. 12 illustrates configurable sizing parameters, according to exemplary embodiments. When the smartphone 200 displays the entry 236, the graphical user interface 204 displays a text field 290 containing a textual description 292 of some content. Some portion or all of the textual description 292 may be displayed in the text field 290, perhaps depending on a font size of the textual description 292 and/or the physical size (such as length, width, and/or area) of the menu 222 of options. When the user touches the entry 236 and inputs the swiping motion 210, the corresponding menu 222 of options is displayed. While the menu 222 of options may have any size and location within, or relative to, the graphical user interface 204, FIG. 12 illustrates the menu 222 of options overlaying or even obscuring a portion of the text field 290. The menu 222 of options, in other words, may be configured or sized (such as length, width, and/or area) to not overlay or obscure a different entry in the listing 232 of content. The displayed size of the menu 222 of options may be standard or equal, regardless of which menu 222 of options is displayed (such as the “Reply” option 260, the “Forward” option 268, or the “Delete” option 274, as illustrated by FIGS. 8-10) in response to the swiping motion 210. Because the displayed area size of the menu 222 of options may be preset or predefined, the font sizing and/or icon sizing within the menu 222 of options may be altered (enlarged or decreased) for visual/tactile clarity. The displayed area size of the menu 222 of options, however, may be variable, again depending on the font sizing and/or icon sizing. A user may also configure the area size of the menu 222 of options to suit her desires.

Exemplary embodiments thus present an elegant solution. Menu management is quickly and easily implemented using the tactile swiping motion 210. The gestural swiping motion 210 is easily learned and perfected, thus requiring minimal physical and cognitive capabilities. Moreover, the direction 220 of the swiping motion 210, and its variable length L and/or percentage 264, may be configured to display its corresponding menu 222 of options. Indeed, as the user swipes in opposite directions (such as i) left-to-right then right-to-left or ii) upward then downward), the corresponding menu 222 of options may be alternatively displayed as the length L and/or the percentage 264 change. The linear direction of the user's swiping motion 210, in other words, may scroll among the different menus of options as the length L and/or the percentage 264 change. Reducing the length L₂ to L₁ (and/or the corresponding percentages 264) changes from the “Forward” option 268 to the previous “Reply” option 260. The linear direction and length L of the user's swiping motion 210 may successively scroll among the different menus of options.

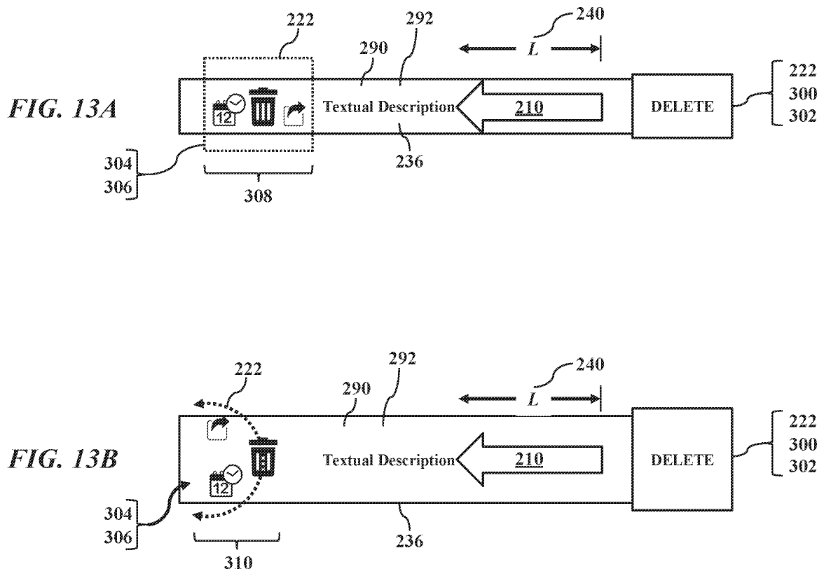

FIGS. 13A-13B further illustrate the menu 222 of options, according to exemplary embodiments. Here the menu 222 of options may display or present multiple options for the user's tactile selection. The menu 222 of options may thus have a first panel component 300 that displays a currently active option 302. The menu 222 of options may also have a second panel component 304 that displays one or more of the individual options 306 associated with the menu 222 of options. While the first panel component 300 and the second panel component 304 may have any size and location within, or relative to, the graphical user interface 204, FIG. 13A illustrates the panel components 300 and 304 overlaying or even obscuring one or more portions of the text field 290. The first panel component 300 and the second panel component 304, in other words, may be configured or sized (such as length, width, and/or area) to not overlay or obscure a different entry. Because there may be multiple options 306 for the user's tactile selection, FIG. 13 illustrates a horizontal listing 308 of the multiple options 306. Each different option 306 (iconically illustrated as calendaring, deleting, or forwarding the selected entry 236) may be represented for the user's tactile selection. If even more options 306 are available (but not displayed, perhaps due to available display space in the second panel component 304), the user may make a left/right horizontal input (perhaps constant engagement) to scroll along additional iconic options 306. The currently active option 302 is displayed by the first panel component 300. As the user horizontally scrolls left/right among the iconic options 306, the first panel component 300 dynamically changes to display each successive active option 302. Once the user has manipulated the menu 222 of options such that the first panel component 300 displays her desired active option 302, the user touches or selects the first panel component 300 for execution.

FIG. 13B illustrates a circular listing 310 of the multiple options 306. Each different option 306 may be represented for the user's tactile selection. The user may make clockwise or counter clockwise inputs (such as constant engagement) to semi-circularly scroll along additional iconic options 306. The currently active option 302 in the menu 222 of options may thus be displayed by the first panel component 300. As the user scrolls among the iconic options 306, the first panel component 300 changes to display the associated currently active option 302. Once the user has manipulated the circular listing 310 such that the first panel component 300 displays her desired active option 302, the user touches or selects the first panel component 300 for execution.

The user may, perhaps at any time, return to the entry 236. Because either the first panel component 300 and/or the second panel component 304 may overlay and/or obscure the textual description 292 in the text field 290, the user may make any input(s) to remove or hide the first panel component 300 and/or the second panel component 304. For example, the user may input a constant, relatively long (such as one second) press (perhaps at any location in the graphical user interface 204). Alternatively, the user may tap, press, or otherwise select any portion of the textual description 292 that is still visible in the text field 290. Regardless, when the user's tactile input is sensed (for example outside the first panel component 300 and/or the second panel component 304), exemplary embodiments may interpret the user's tactile input as a command or action to remove or hide the panel components 300 and 304. The smartphone 200 and the software application 202 may cooperate to save the user's state (the option that she currently or previously selected. The panel components 300 and 304 are hidden from visual display and the text field 290 is restored to its full size.

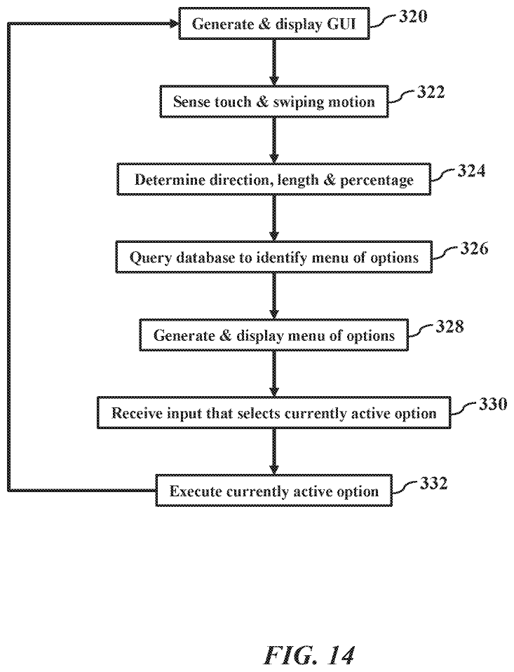

FIG. 14 shows a method or algorithm for graphical menu configuration, according to exemplary embodiments. The graphical user interface 204 is generated and displayed (Block 320). The user's swiping motion 210 is sensed (Block 322). The direction 220, the length 240, and/or the percentage 264 associated with the swiping motion 210 is determined (Block 324). The electronic database 280 is queried to identify the corresponding menu 222 of options (Block 326). The menu 222 of options is generated and displayed (Block 328). An input is received that selects the currently active option 302 (Block 330). The active option 302 is executed (Block 332).

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. A method, comprising:
capacitively sensing, by an information handling system, an input to a touch sensitive display;
determining, by the information handling system, a length associated with the input to the touch sensitive display;
determining a disengagement associated with the input to the touch sensitive display;
identifying a menu of options by querying an electronic database for the length associated with the input to the touch sensitive display, the electronic database electronically associating menus to lengths including the menu of options that is electronically associated with the length associated with the input to the touch sensitive display;
generating the menu of options; and
displaying the menu of options at the disengagement.

2. The method of claim 1, further comprising displaying a graphical user interface.

3. The method of claim 1, further comprising displaying a listing of content.

4. The method of claim 3, further comprising presenting the menu of options overlaying an entry in the listing of content.

5. The method of claim 1, further comprising presenting a listing of messages.

6. The method of claim 5, further comprising presenting the menu of options overlaying a message in the listing of messages.

7. The method of claim 1, further comprising presenting an active option of the menu of options.

8. A system comprising:
a hardware processor; and
a memory device accessible to the hardware processor and storing instructions that when executed by the hardware processor perform operations, the operations including:
presenting a listing of content by a touch sensitive display;
capacitively sensing an input to the touch sensitive display;
interpreting the input as a selection of an entry in the listing of content presented by the touch sensitive display;
capacitively sensing a swiping motion from a leading edge along the entry in the listing of content;
determining a length associated with the swiping motion;
identifying a menu of options by querying an electronic database for the length associated with the swiping motion, the electronic database electronically associating menus of options to lengths including the length associated with the swiping motion; and
displaying, at the leading edge of the swiping motion, the menu of options by the touch sensitive display.

9. The system of claim 8, wherein the operations further include presenting a graphical user interface.

10. The system of claim 8, wherein the operations further include presenting the menu of options overlaying the entry in the listing of content.

11. The system of claim 8, wherein the operations further include presenting a listing of messages as the listing of content.

12. The system of claim 8, wherein the operations further include presenting an active option of the menu of options.

13. The system of claim 12, wherein the operations further include capacitively sensing a selection of the active option.

14. The system of claim 12, wherein the operations further include executing the active option.

15. A non-transitory memory device storing instructions that, when executed by a hardware processor, perform operations, the operations including:
displaying a listing of content by a touch sensitive display;
capacitively sensing an input to the touch sensitive display;
interpreting the input as a selection of an entry in the listing of content displayed by the touch sensitive display;
capacitively sensing a swiping motion from an engagement to a disengagement along the entry in the listing of content displayed by the touch sensitive display;
determining a length associated with the swiping motion;
determining a maximum permissible length associated with the swiping motion;
in response to the length associated with the swiping motion exceeding the maximum permissible length, declining an interpretation of the swiping motion;
in response to the length associated with the swiping motion being less than or equal to the maximum permissible length, identifying a menu of options by querying an electronic database for the length associated with the swiping motion, the electronic database electronically associating menus of options to lengths including the length associated with the swiping motion; and
displaying the menu of options at the engagement by the touch sensitive display.

16. The non-transitory memory device of claim 15, wherein the operations further include displaying a graphical user interface.

17. The non-transitory memory device of claim 15, wherein the operations further include displaying the menu of options overlaying the entry in the listing of content.

18. The non-transitory memory device of claim 15, wherein the operations further include displaying a listing of messages as the listing of content.

19. The non-transitory memory device of claim 15, wherein the operations further include displaying an active option of the menu of options.

20. The non-transitory memory device of claim 15, wherein the operations further include capacitively sensing a selection of the active option.
